(19) United States
(12) Patent Application Publication
(10) Pub. No.: US 2009/0123334 A1
(43) Pub. Date: May 14, 2009

(54) Device and Method for Monitoring the Temperature to Which a Product has Been Exposed

(76) Inventors: Massimiliano Cavallini, Vergato (IT); Fabio Biscarini, Bologna (IT); Francesco Cino Matacotta, Bologna (IT); Pablo Alberto Stoliar, Bologna (IT)

Correspondence Address: GREER, BURNS & CRAIN, 300 S WACKER DR, 25TH FLOOR, CHICAGO, IL, 60606, US

(21) Appl. No.: 11/992,203

(22) PCT Filed: Sep. 19, 2006
(86) PCT No.: PCT/EP2006/009091

§ 371 Date: Mar. 18, 2008

(30) Foreign Application Priority Data
Sep. 23, 2005 (IT) MI2005A001778

(51) Int. Cl. G01K 11/06

(52) U.S. Cl. 422/56; 422/55; 422/57

(57) ABSTRACT

A device for monitoring the temperature to which a product has been exposed, comprising at least one spatially structured element, constituted by a material indicating a preset level of temperature and a preset exposure time interval, and adapted to be applied to a monitored product. The indicator material is selected among materials which detectably change their morphological and/or structural and/or chemical and/or physical state once the material is placed in a condition in which it can absorb a preset amount of heat.

The present invention relates to a device and a method for monitoring the temperature to which a product has been exposed, and to a label provided with such a device.

### BACKGROUND ART

The quality and safety of many products are affected by temperature.

Particularly but not exclusively, this is the case of refrigerated and frozen foodstuffs, of beverages which require preservation under controlled low temperatures, such as wine for example, and of certain cosmetic, medical and pharmaceutical products.

The two main factors that contribute to the loss of sanitary, nutritional and visual quality of perishable products are in fact time and temperature: more precisely, the rise beyond a critical temperature threshold which interrupts the so-called “cold chain” from the producer to the consumer of the product and/or its exposure for a more or less long time to a temperature which is higher than the one prescribed for safe preservation during a guaranteed period of preservation.

Other products, such as clothes, also may be deteriorated if exposed to excessively high temperatures, for example during cleaning or washing.

Therefore, temperature control and monitoring are very important during the processing, maintenance, storage and distribution of a product and have become an essential requirement.

The temperature of a product must be kept at the preset level and checked at regular intervals at each critical point of the distribution chain. Control is therefore an important instrument in checking the safety and quality of consumer products.

Checking the relevant information requires time, specific knowledge and a suitable material. If the cost and complexity of use of the temperature monitoring means are high, this often leads to fewer checks or even to no checks useful to ascertain whether the products are safe and of good quality.

Temperature indicators capable of indicating whether the temperature of the product has reached or not the preset threshold are known for highlighting events which are harmful for products.

Time-temperature integrators are also known which measure simultaneously time and temperature and integrate these data in a single visible result. In this manner, they provide the complete time-temperature history of the products with which they are associated. These are generally indicators which can also be provided in the form of self-adhesive labels affixed to the products to be monitored.

Conventional indicators include substances which can undergo a color change caused by the influence of time and temperature. These indicators must often be kept frozen until they are used, due to the presence of chemical products which are sensitive to even small temperature variations, which cause an irreversible change of their relevant characteristics.

Other systems are based on the diffusion of a chemical substance which has a specific melting point. Once activated, the chemical substance starts to diffuse at a diffusion rate which depends on the temperature; the degree of diffusion provides a measurement of the accumulated time-temperature history, but only with reference to the specific temperature threshold defined by the choice of the chemical substance and by its concentration.

Other known temperature sensors are based on the use of electrical devices of varying complexity. In all cases, devices are needed whose complexity varies according to the required performance.

Complex systems are therefore used which are based on identification devices which use resistive sensors, diodes, thermocouples, heat transducers, or radio frequencies (RFID—Radio Frequency Identification Device). RFIDs are capable of providing a signal which changes according to the temperature to which they are subjected, allowing to record information regarding the time-temperature history for each package. This information can be transferred by means of a scanner to a computer which is capable of calculating the preservation period.

In general, known indicators are arranged at the surface, in order to facilitate reading, and this entails a reaction to ambient temperature, which is generally more significant than the reaction that occurs inside the product. The relation between the surface temperature and the temperature inside the product varies from one product to another depending on the material of the packaging, on the physical properties, on the voids, et cetera.

The time-temperature relation between temperature history and preservation duration is not the same for all food or medical products.

Due to the great diversity of the biological and chemical material and of the processing and packaging methods, when using time-temperature indicators it is difficult to quantify directly the actual quality and safety of each product. However, the quality of the preservation and the residual preservation time of the product, as regards time and temperature, and any rise beyond the temperature preset by the manufacturer can in any case be measured and monitored for each individual product, thus providing a valid indication for the safety of the consumer.

For this reason it is necessary to have a large number of indicators, even ones which are calibrated in different manners.

Therefore, it becomes difficult and complicated to adjust the results of the indicators on the basis of the type of material used for them, of the concentration and of their specific physical and chemical parameters, which vary according to the temperature, so that said indicators can reproduce the exact conditions of the product, moreover, no unified international standards which indicate acceptable levels of precision are available to compare devices made by different manufacturers.

The use of these indicators is often limited to the main packaging, allowing clear viewing of the distribution only from the producer to the retailer, but direct information for consumers is not available.

This occurs because the cost of a single indicator, when placed on the packaging or directly on the products presented to consumers, including the cost for its application, may be high in relation to the value of certain products.

The main limitation of known sensors is constituted by the manufacturing cost but also by the complexity of the systems for detecting the indications that they provide, which make these products non-competitive and difficult to use for mass productions and large varieties.

### SUMMARY OF THE INVENTION

The aim of the present invention is to provide a device and a method for monitoring the temperature to which a product has been exposed which is easy and inexpensive to manufacture in large quantities and with different calibrations as regards both the preset temperature or temperatures and the time of exposure to said temperature or temperatures.

Another object of the invention is to provide a device and a method for monitoring the temperature to which a product has been exposed which can provide exact indications on whether the preset temperature has been exceeded and also as regards the duration of the exposure to said temperature, in a manner which is simple and easy to assess by ordinary users.

Another object of the invention is to provide a device and a method for monitoring the temperature to which a product has been exposed which is easy and safe to apply to any kind of product, including food or medical-pharmaceutical products.

Still another object of the invention is to provide a device and a method for monitoring the temperature to which a product has been exposed which can be obtained with known materials which are internationally acceptable as compatible with particular uses, such as in the food sector or in the medical-pharmaceutical sector, and are easily commercially available.

This aim and these and other objects, which will become better apparent hereinafter, are achieved by a device for monitoring the temperature to which a product has been exposed, according to the present invention, characterized in that it comprises at least one spatially structured element, which is constituted by a material which indicates a preset level of temperature and a preset exposure time interval, said spatially structured element being adapted to be applied to the product to be monitored, said indicator material being selectable among materials which detectably change their morphological and/or structural and/or chemical and/or physical state once the material is placed in a condition in which it can absorb a preset amount of heat.

The invention also relates to a method for monitoring the temperature to which a product has been exposed which comprises the step of selecting an indicator material constituted by one or more substances capable of changing state at a preset threshold temperature and the step of forming at least one spatially structured element, which has a configuration whose total volume is adapted to ensure a detectable change of state when a time interval equal to, or greater than, a preset time interval elapses and which is adapted to be applied to the product to be monitored.

### BRIEF DESCRIPTION OF THE DRAWINGS

Further characteristics and advantages of the invention will become better apparent from the description of preferred but not exclusive embodiments of the device and the method according to the invention, illustrated by way of non-limiting example in the accompanying drawings, wherein:

FIG. 1 is a schematic view of the possible behavior or action of the device in a first embodiment according to the invention during the absorption of heat, with melting of the material of which it is made;

FIG. 2 is a schematic view of the possible behavior or action of the device according to the invention in a second embodiment, during the absorption of heat, with crystallization of the material of which it is made;

FIG. 3 is a schematic view of the possible behavior of the device according to the invention in a third embodiment, in which the absorption of heat induces a phase segregation of the material of which it is made, with aggregate formation of initially dispersed substances;

FIG. 4 is an atomic-force microscope image of the device according to the invention, wherein in particular FIG. 4a illustrates the initial morphology of the device, FIG. 4b illustrates the morphological profile of FIG. 4a measured along the line 1, FIG. 4c illustrates the morphology of the device after action, and FIG. 4d illustrates the morphological profile of FIG. 4c measured along the line 2;

FIG. 5 is a graphical representation of the variation, as a function of time, of the degree of surface roughness of the device in terms of variation of its morphological profile as a function of time in an embodiment according to FIG. 1 at a temperature of 150° C.;

FIG. 6 shows an example of the indirect consequences of heat absorption of the device of FIG. 1 according to the invention, which can be detected by white-light illumination, and in particular FIG. 6a illustrates the device in the initial condition, and FIG. 6b illustrates the device after heat absorption;

FIG. 7 shows a formula of a rotaxane molecule for providing the device according to the embodiment of FIG. 2;

FIG. 8 shows an example of the device made with formation of detectable spatial crystals, according to the embodiment of FIG. 2.

### DESCRIPTION OF THE PREFERRED EMBODIMENTS

With reference to the figures, the device for monitoring the temperature to which a product has been exposed according to the invention comprises at least one spatially structured element 1, which is constituted by a material which indicates a preset threshold temperature level Tes and a preset exposure time interval Tis. The spatially structured element 1 is provided so that it is adapted to be applied to the product to be monitored. The indicator material can be selected conveniently among materials which change their morphological and/or structural and/or chemical and/or physical state.

The change of state can be detected after placing the material in a condition in which it can absorb a preset amount of heat, which is determined by the absorption, by the indicator material, of a heat flow generated by reaching the preset threshold temperature Tes and/or by exposing said indicator material to a temperature T which is equal to, or greater than, the preset threshold temperature Tes for a time interval Δt which is greater than a preset time interval Tis.

The device therefore bases its operation on a change of morphology and/or on a chemical and/or a physical surface alteration of an indicator material, which can be massive or in film form (thickness preferably but not exclusively ranging from 100 μm to 1 μm) or in the form of a thin film (thickness preferably but not exclusively lower than 1 μm) as a consequence of a thermal stimulus. The thermal stimulus arises from the exposure of the product to a temperature which must exceed Tes for a time which is longer than Tis in order to allow the transformation of the material.

In a preferred but not exclusive embodiment, the device consists of a thin structured label, which constitutes the structured element 1 and comprises a base layer 4 with a surface or interface 2 for exposure to the surrounding medium. It is further possible to cover the surface 2 with a protective coating. The device can be structured by means of any molding or self-structuring or other known suitable process. The structured elements 1 made of indicator material change appearance and/or size when the label is subjected to a high temperature (i.e., a temperature greater than or equal to Tes) for a sufficiently long time Δt (i.e., greater than or equal to Tis).

The exposure of the device to temperatures which are higher than the threshold temperature Tes reduces Tis proportionally.

The device is calibrated both in terms of temperature and in terms of time of exposure to temperature.

The change of appearance of the device, hereinafter referenced as “action”, can be morphological, structural and/or chemical or of another type which can be detected for the purposes of the invention and can occur at several spatial scales:
macroscopic scale: the device contains structured elements 1 having lateral spatial dimensions or widths d ranging from 5 mm to 200 μm; the morphological changes to these structures 1 and the structures themselves can be observed directly even with the naked eye;
micrometer scale: the device contains structures 1 having lateral spatial dimensions or widths d ranging from 200 μm to 1 μm; the morphological changes to these structures 1 and the structures themselves can be observed directly only with the aid of a specific reader or a microscope;
submicrometer and nanometer scale: the device contains structures 1 having lateral spatial dimensions or widths d comprised between 1 μm and 1 nm; the morphological changes to these structures 1 and the structures themselves can be observed directly with the aid of a specific reader or an electronic microscope or scanning probe microscopes.

As an alternative, or in addition, the morphological changes can be detected indirectly due to physical phenomena, such as for example changes in effects of light diffraction or changes in electrical conductivity, magnetic or electrical susceptivity and/or heat capacity and/or others.

For the sake of simplicity in description, reference is made hereinafter, without thereby losing generality, only to “films”, although the concept remains valid also for materials of any thickness.

The film is constituted by the indicator material which comprises one or more pure or mixed substances. Such substances can belong to the inorganic, organic, polymeric, biological, hybrid classes or other classes suitable for the purpose.

The film has at least one surface or interface 2 for exposure to the surrounding medium having a structured configuration 3 and can be shaped with any molding technique or other suitable technique; its morphological structure (hereinafter also referenced as modeling) can also be spontaneous as a consequence of a technological process for manufacture or deposition of the film.

The threshold temperature Tes is the temperature at which the material that constitutes the film undergoes the transformation. In particular cases, Tes can coincide with the temperature at which the material that constitutes the device passes from the solid state to the fluid state in the environmental conditions in which the device works. By way of non-limiting example, Tes, in ordinary conditions, may coincide with the melting temperature of the material that constitutes the device or with the glass transition temperature (Tg) in polymeric systems.

The environmental conditions include the cases in which the transition to the fluid state also includes the intervention of agents which are external to the material (for example the presence of a solvent which lowers the Tg of a polymer).

The structured configuration 3 of the device forms an exposure surface 2 with high roughness, provided by a plurality of protrusions 5 which are mutually separated by respective spaces 7, the protrusions 5 and the spaces 7 having, in a transverse cross-section taken along a plane which is perpendicular to the rough surface, a profile shaped like an open polygonal line with substantially pointed edges 6. The protrusions 5 are made of an indicator material which is suitable to undergo a shape change following exposure to temperatures which are equal to, or greater than, a preset threshold temperature Tes and have spatial dimensions, in terms of height h and width d and, selected so that they flatten until they fill with material the spaces 7 when a time interval Δt of exposure to said temperatures elapses which is equal to, or greater than, the preset exposure time interval Tis. Following the shape change, the edges 6 form rounded regions 8, which attenuate the degree of detectable roughness of the exposure surface 2, the maximum rounding radius r being reached when the preset time interval Tis elapses. Indeed, due to the transition to the fluid state, the modeled film loses its shape, becoming rounded (i.e., becoming less rough).

In another embodiment, the film changes its structural state or more generally undergoes a chemical and/or physical and/or morphological alteration, which comprises the segregation of materials that constitute the film, dewetting (i.e., transformation of a uniform film of substance due to the temperature into “drops”, which are perceived as an increased roughness of the base layer), crystallization and others.

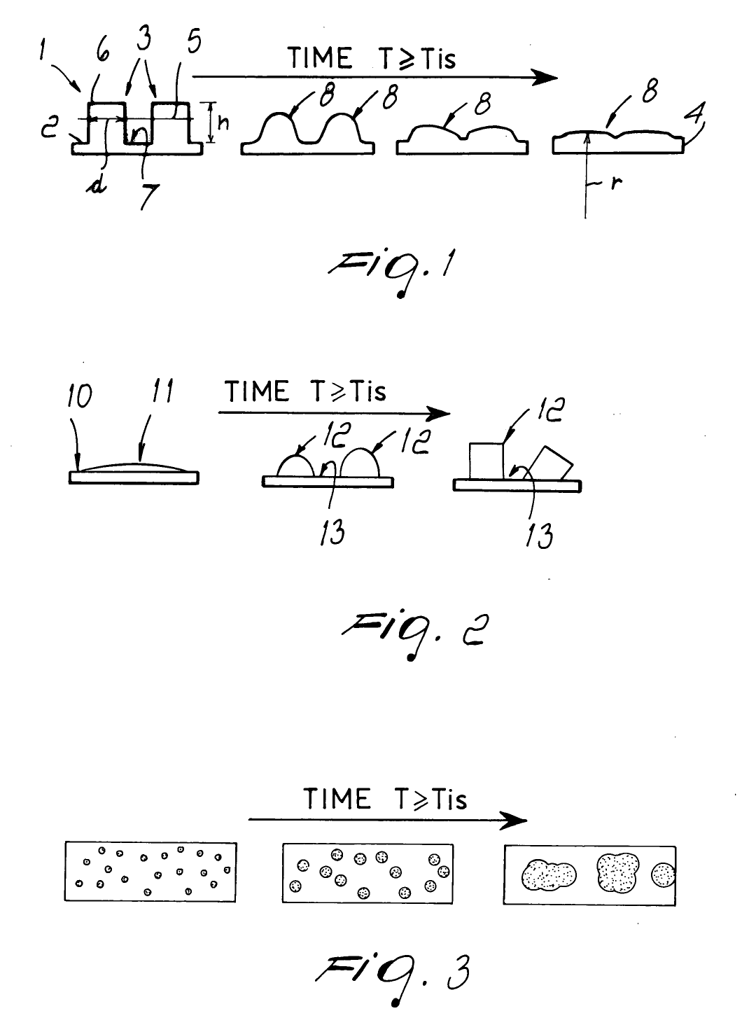

By way of non-limiting example, three possible diagrams or embodiments of the action of the device are indicated in FIGS. 1, 2 and 3.

In FIG. 1, heat absorption melts the modulations or protrusions 5, which under the effect of surface tension become rounded until they disappear.

In FIG. 2, heat absorption allows crystallization of the indicator material that constitutes the device, which comprises initially a low-roughness exposure surface 10 constituted by a volume 11 of material which increases and changes its morphology, generating protrusions 12 and spaces or grooves 13, and this causes an increase in surface roughness.

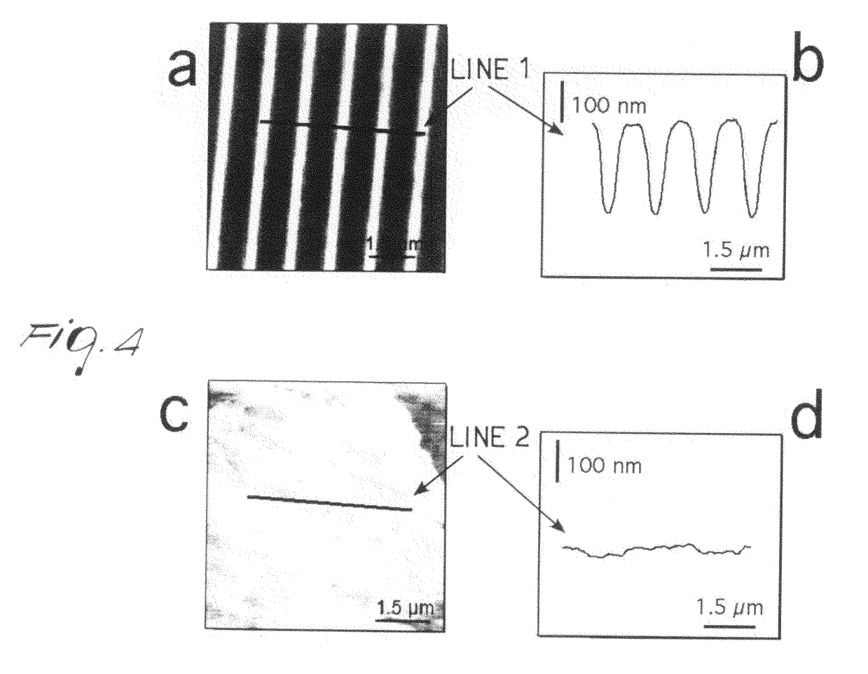

In FIG. 3, heat absorption induces a phase segregation, consequently forming aggregates of the substances that were initially dispersed.

In the first embodiment of FIG. 1, the physical principle on which the process is based is the effect of surface tension on fluids. When the surface of the material that constitutes the structured element 1 becomes fluid due to the thermal stimulus, the surface tension tends to minimize the area of the surface. The effect of this process is to round the modulations or protrusions 5 of the exposure surface 2.

In the second example of FIG. 2, the physical principle on which the process is based is crystallization. The material or substance that constitutes the structured element 1 crystallizes following the absorption of heat, forming spatial structures which can be detected as surface roughness.

In the third example of FIG. 3, due to the change of state caused by the absorption of heat, additional processes can occur, including a phase segregation of the substances that constitute the structured element 1 and/or the migration toward the surface of one or more of the components and the aggregation of small particles so as to form larger particles during the action; this, too, can be detected for example as an increase in surface roughness or as a change in optical properties. The substances used can be different one another and capable of interacting chemically and/or physically, forming a substance which may even be different from the initial ones.

The change of state of the device therefore occurs as a consequence of the absorption of heat. The preset time required for the action of S-TAG (Tis) depends on:
the material of which the structured element 1 is made, in particular its heat capacity. In general, the higher the heat capacity, the longer the time required for the action of the device.
the exposure temperature. The Tis for the action of the device decreases as the exposure temperature of the device increases with respect to Tes.
the Tis for the action of the device decreases as the volume of the surface modulations or protrusions 5 decreases.
for an equal volume of the surface modulations or protrusions 5, Tis becomes shorter as the protrusions 5 increase in roughness or height.

In general, the trend of the rounding can be estimated by the following phenomenological equation:

$$\frac{d h}{d t} = - K ( T ) {T}^{α} {V ( h )}^{β}$$

where h is the height of the structure, T is the temperature, V is the volume of the structured element, and K depends on the material that constitutes the device. The parameters α and β are exponential factors which depend specifically on the system.

Examples of α and β and K, are α=1, and β=1, and K=0.5.

The conditions of action of the device must be calibrated for each type of device by identifying: the material, the dimensions and shape of the modulations or protrusions 5 of the structured configuration 3.

Merely by way of non-limiting example, the case of a device which refers to the embodiment of FIG. 1 is presented hereafter.

A polymer (polycarbonate) is used as a temperature sensing indicator material, specifically having the following values:

microstructured film with grooves or spaces 7 having a pitch of 1.5 μm, a width of 500 nm and a depth (h) of 220 nm.

The particular operating specifications are:

Tes=150° C.

Tis=2 minutes

The morphological change undergone: rounding of the grooves 7, which is visible directly with an atomic force microscope and indirectly by means of the disappearance of the diffraction effects.

FIG. 4 shows an atomic force microscope image of the structured element 1, which shows the particular action which consists of the disappearance of the grooves or spaces 7 provided initially on the surface 2 following exposure to 170° C. for 2 minutes.

FIG. 4a illustrates the initial morphology of the device. FIG. 4b illustrates the morphological profile of FIG. 4a, measured along the line 1 of FIG. 4a. FIG. 4c illustrates the morphology of the device after action, i.e., after heat absorption. FIG. 4d illustrates the morphological profile of FIG. 4c, measured after action along the line 2 of FIG. 4c.

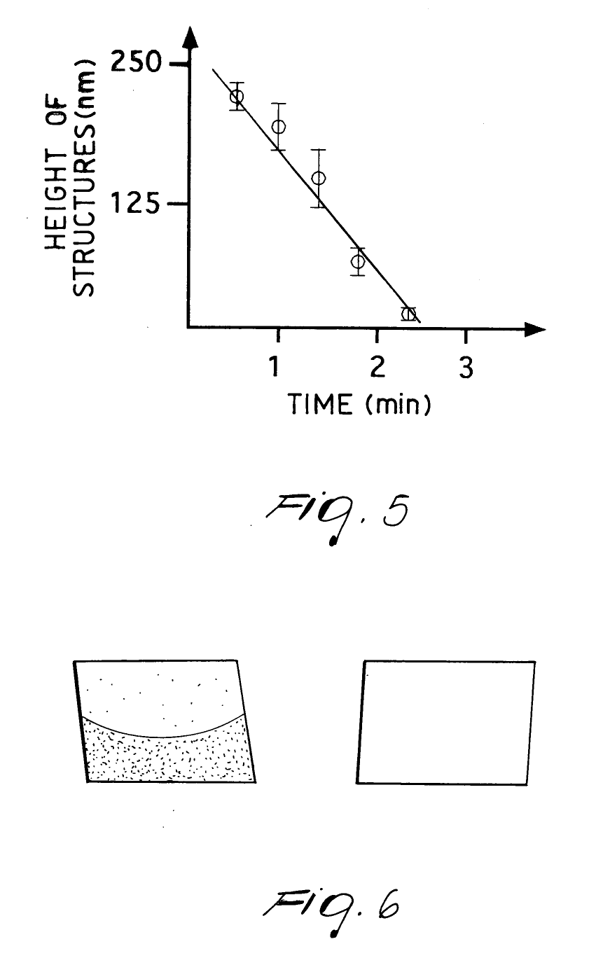

FIG. 5 plots as a function of time the degree of roughness, i.e., of surface roughness during heat absorption. This behavior is expressed as the extension of the morphological profile (height h) of the structures (protrusions 5) as a function of the time of exposure to the Tes (i.e., 150° C.).

FIG. 6 is an example of the detectable indirect consequences of the action of the device of FIG. 1. In particular, FIG. 6a illustrates the device before action. In this case, the structured element 1 exhibits diffraction when lit appropriately with white light. FIG. 6b is a view of the device after action, i.e., after the shape change following heat absorption. Due to the change in morphology, shown in FIG. 1, the device no longer exhibits white light diffraction.

In its embodiment based on rounding due to melting, the device can use all the materials that melt at the Tes, provided that they are compatible with the field of use. Examples of systems which reduce surface roughness due to the action according to the first embodiment are: frozen chemical solutions whose surface has been modeled, polymers, molecular materials, low-melting salts, metals and others.

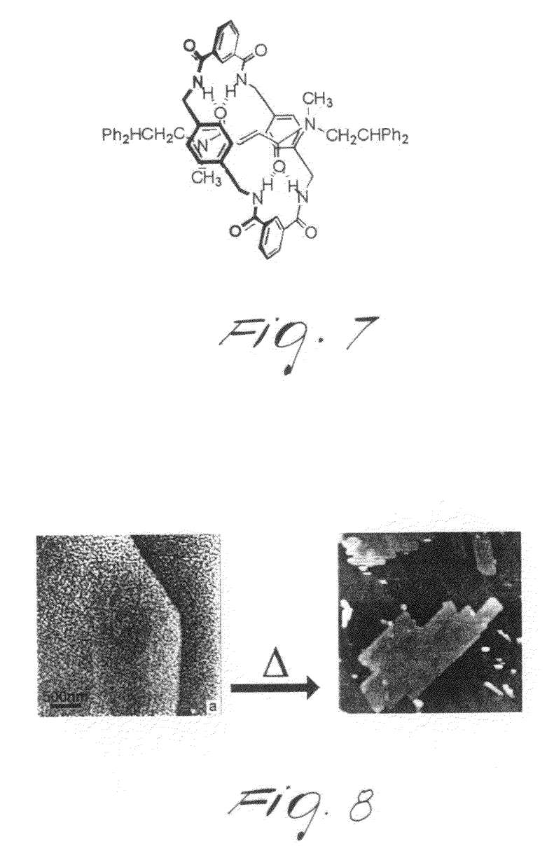

Merely by way of non-limiting example, the case is described hereinafter of a device which refers to the second embodiment of FIG. 2, i.e., wherein, due to the action (heat absorption and shape change), the surface roughness increases. In this second embodiment, a thin film with thickness of 20 nm of a molecule known as rotaxane, whose formula is shown in FIG. 7, is used as temperature sensing indicator material.

The particular operating specifications are:

Tes=50° C.

Tis=20 minutes

After the action, the morphology of the film changes completely due to crystallization of the material. The action can be monitored as a morphological variation, as an increase in surface roughness, as a development of the correlation length, and others.

An example of crystal formation is shown in FIG. 8. In this case, the roughness of the system measured on areas of 10×10 μm² ranges from 1 nm to 10 nm.

Other examples of systems which increase surface roughness are, due to the action, constituted by materials/substances which belong to the class of liquid crystals and others capable of crystallizing at preset known temperatures.

Examples of materials which produce a phase segregation under the action of time and temperature, as in the case shown in FIG. 3, are clusters of [Mn₁₂O₁₂(O₂CC₁₂H₉)₁₆], which once dispersed in a polycarbonate matrix segregate spontaneously, forming aggregates due to the temperature. In this case, examples of the parameters are as follows:

Tes=150° C.

Tis=3 minutes.

The change of morphological and/or structural and/or chemical and/or physical state of the indicator material may include, in a preferred but not exclusive embodiment of the invention, also a change in color or a change in physical properties, such as for example electrical conductivity. This change, for example, can be obtained as an effect in addition to shape changing, by including in the indicator material additional substances capable of providing a further indication as to the exposure of the product to harmful temperatures.

The device, in this embodiment, can be calibrated in order to undergo shape changes when a first threshold temperature Tes1 is reached and when a first exposure time Tis1 elapses and a second change of color or of another physical property at a second threshold temperature Tes2 and when a second exposure time Tis2 has elapsed. Obviously, Tes1, Tes2, Tis1 and Tis2 can be preset appropriately in order to have any values with respect to each other, i.e., one or the other can be greater than the other.

Examples of materials/substances that change color properties (optical and spectroscopic properties) and physical properties (for example electrical conductivity) when they come into contact after melting are:
a dispersion of litmus in a polymeric matrix. This produces a color change when acidity changes. The dispersion has the property of becoming red in contact with acid substances.

The second material/substance can be constituted by a polymer which contains acid groups (for example acrylic polymers and/or copolymers).

When the two materials come into contact as a consequence of melting and chemical reaction, the system shifts from colorless to a red color whose intensity and degree of extension in the indicator material depends as a whole on the quantity of the materials/substances that are included, and different calibrations for chosen times and temperatures are possible.
A polymer which contains acid groups comes into contact, as a consequence of melting, with polyaniline, changing its electrical conductivity due to a doping effect. In this case also, multiple calibrations are possible.

From the above description of some preferred but not exclusive embodiments of the device, it can be deduced that the invention also provides a method for monitoring the temperature to which a product has been exposed which comprises steps of selecting an indicator material constituted by one or more substances capable of changing state at a preset threshold temperature Tes and of forming at least one spatially structured element 1 with a configuration 3 whose total volume is adapted to ensure a detectable change of state when a time interval equal to, or greater than, a preset time interval Tis elapses, the device being further adapted to be fixed to the product to be monitored.

In practice it has been found that the above described device and method for monitoring the temperature to which a product has been exposed are capable of providing very accurate indications as to the conditions of preservation of a product at very convenient costs which do not affect the overall cost of the product itself.

The device according to the invention provides indications which can be detected easily even by non-expert users directly at the point of sale, allowing them to avoid the purchase of a product which is potentially altered or has a short remaining preservation time.

In this regard, moreover, the device can comprise a region of the structured element 1 which is made of a substance which is insensitive to the preset temperature threshold, initially with a configuration which is identical to the rest of the element, and remains unchanged even after this temperature has been exceeded, providing the user with a reference/comparison element which instead bears witness to the change of roughness of the device when the product is subjected to harmful temperatures.

The described invention is applicable in the most disparate industrial and nonindustrial fields, such as the agroalimentary, medical and pharmaceutical, textile, footwear, and electronic fields, in general for consumer goods or others.

The system thus conceived is susceptible of numerous modifications and variations, all of which are within the scope of the inventive concept as expressed in the appended claims.

The disclosures in Italian Patent Application No. MI2005A001778 from which this application claims priority are incorporated herein by reference.

Where technical features mentioned in any claim are followed by reference signs, those reference signs have been included for the sole purpose of increasing the intelligibility of the claims and accordingly, such reference signs do not have any limiting effect on the interpretation of each element identified by way of example by such reference signs.

1-28. (canceled)

29. A device for monitoring the temperature to which a product has been exposed, comprising at least one spatially structured element, which is constituted by an indicator material which indicates a preset level of temperature and a preset exposure time interval, said spatially structured element being suitable to be applied to the product to be monitored, said indicator material being selectable among materials which detectably change their morphological and/or structural and/or chemical and/or physical state once the material is placed in a condition in which it can absorb a preset amount of heat.

30. The device according to claim 29, wherein the preset amount of heat suitable to determine the change of state of the indicator material is determined by the absorption, by said indicator material, of a heat flow generated by the attainment of a preset threshold temperature and/or by the exposure of said indicator material to a temperature which is equal to, or greater than, the preset threshold temperature for a time interval which is longer than a preset time interval.

31. The device according to claim 29, wherein said structured element comprises a film made of said indicator material, which has at least one surface or interface for exposure to the surrounding medium which has a structured configuration, said surface being optionally coverable with a protective coating.

32. The device according to claim 29, wherein said structured element comprises a thin label, which can be applied to a product to be monitored and is made of said indicator material.

33. The device according to claim 29, wherein said structured element is constituted by a label which comprises a base layer with a surface for exposure to the surrounding medium to which a structured configuration made of said indicator material is applied.

34. The device according to claim 29, wherein said indicator material comprises one or more substances in the pure or mixed state, said substances being selectable among inorganic, organic, polymeric, biological or hybrid substances.

35. The device according to claim 29, wherein said structured element is a molded element.

36. The device according to claim 33, wherein said structured configuration forms a high-roughness exposure surface provided by a plurality of protrusions which are mutually separated by respective spaces, said protrusions and said spaces having, in a transverse cross-section taken along a plane which is perpendicular to said rough surface, a profile shaped like an open polygonal line with substantially pointed edges.

37. The device according to claim 36, wherein said protrusions are made of an indicator material which is suitable to undergo a shape change and/or state change following exposure to temperatures which are equal to, or greater than, said threshold temperature.

38. The device according to claim 37, wherein said protrusions have spatial height and width dimensions selected so that the protrusions flatten until they fill with material said spaces when a time interval of exposure elapses which is equal to, or greater than, the preset exposure time interval, said edges forming rounded portions which attenuate the detectable degree of roughness of said exposure surface.

39. The device according to claim 38, wherein said rounded portions have their maximum rounding radius when said preset time interval elapses.

40. The device according to claim 30, wherein said indicator material is selected with a melting temperature or a glass transition temperature which is equal to the preset threshold temperature.

41. The device according to claim 33, wherein said structured configuration forms a low-roughness exposure surface, constituted by a volume of said indicator material.

42. The device according to claim 41, wherein said indicator material which forms said volume is suitable to undergo a shape change and/or state change following exposure to temperatures which are equal to, or greater than, said threshold temperature for a time interval which is greater than the preset time interval.

43. The device according to claim 42, wherein said indicator material is selected in order to be suitable to form, as a consequence of said shape change, protrusions, segregated protrusions, or protrusions separated by grooves, said exposure surface having an increased degree of detectable roughness with respect to the initial state when said preset time interval elapses.

44. The device according to claim 43, wherein said indicator material is selected so that said shape change is determined by its crystallization.

45. The device according to claim 43, wherein said indicator material is selected so that said shape change is determined by dewetting.

46. The device according to claim 33, wherein said structured configuration comprises at least two mutually separated structured elements, which are constituted by different substances capable of reacting as a consequence of said shape change.

47. The device according to claim 37, wherein said indicator material comprises a plurality of substances, said protrusions being constituted by mutually different substances capable of interacting chemically and/or physically following said shape change of said material and of formation of a substance which is different from the initial substances.

48. The device according to claim 47, wherein one of said substances is insensitive to the temperature increase beyond said preset threshold temperature and constitutes a reference structured element which is suitable to provide a comparison element for the change of state of the other structured elements.

49. The device according to claim 42, wherein said change of state is a change of the chemical and/or physical properties of the material, such as color and/or heat conductivity and/or electrical conductivity and/or diffraction index and/or magnetic susceptivity and/or electrical susceptivity and/or heat capacity and/or optical properties and/or spectroscopic properties.

50. The device according to claim 49, wherein the preset time suitable to determine any change of state of the indicator material is determined by the volume of the spatially structured element or elements.

51. The device according to claim 49, wherein the preset time suitable to determine the change of state of the indicator material is determined by the volume and shape of the spatially structured element or elements.

52. The device according to claim 49, wherein the preset time suitable to determine the change of state of the indicator material is determined by the volume of the surface roughness of the spatially structured element or elements.

53. The device according to claim 49, wherein the preset time suitable to determine the change of state of the indicator material is determined by the combination in any ratio of volume, shape and surface roughness of the spatially structured element or elements.

54. The device according to claim 49, wherein the preset time suitable to determine the change of state of the indicator material is determined by the volume and heat capacity of the spatially structured element.

55. The device according to claim 42, wherein said change of the chemical and/or physical properties of the material, such as color and/or heat conductivity and/or electrical conductivity and/or diffraction index and/or magnetic susceptivity and/or electrical susceptivity and/or heat capacity is an additional change with respect to shape change, preferably determined by exposure to threshold temperatures and/or by the elapsing of exposure time intervals which are preset to be different from the ones that determine the change of shape.

56. A method for monitoring the temperature to which a product has been exposed by means of the device according to claim 29, comprising the steps of:
selecting an indicator material constituted by one or more substances capable of changing state at a preset threshold temperature;
forming at least one spatially structured element with a configuration whose total volume is suitable to ensure a detectable change of state when a time interval which is equal to, or greater than, a preset time interval elapses, the element being adapted to be applied to the product to be monitored.
